(19) United States
(12) Patent Application Publication
(10) Pub. No.: US 2022/0072745 A1
(43) Pub. Date: Mar. 10, 2022

(54) POLYMER MATERIAL SUPERCRITICAL FLUID FOAMING AUTOCLAVE WITH INTERNAL HEAT EXCHANGE

(71) Applicant: GUANGZHOU GREEN AND HEALTH BIOTECH CO., LTD., GUANGZHOU (CN)

(72) Inventors: HANCHA LIU, GUANGZHOU (CN); YUAN LIANG, GUANGZHOU (CN); SHUHUA WU, GUANGZHOU (CN); JIANYU XU, GUANGZHOU (CN); GUOHANG YANG, GUANGZHOU (CN); JITAO XU, GUANGZHOU (CN); JIAQI LIANG, GUANGZHOU (CN); YUEHUA LIU, GUANGZHOU (CN); YUHAO CHEN, GUANGZHOU (CN)

(21) Appl. No.: 17/016,406

(22) Filed: Sep. 10, 2020

(51) Int. Cl. B29C 44/10; B29C 44/34

(52) U.S. Cl. CPC B29C 44/105; B29C 44/3403; B29K 2105/04; B29C 44/3415; B29C 44/348

(57) ABSTRACT

The invention discloses a polymer material supercritical fluid foaming autoclave with internal heat exchange, comprising a horizontal autoclave body, an end cover and a spiral heat exchange coil pipe, wherein the heat exchange coil pipe is positioned inside the autoclave body and is mounted against an inner wall of the autoclave body, and a high/low-temperature heat exchange medium can be introduced into the heat exchange coil pipe. According to the invention, the internal heat exchange coil pipe is adopted for heat exchange, so that the heat exchange medium can directly and efficiently exchange heat with the supercritical fluid in the autoclave, and the heat exchange efficiency is improved, which solves the problems of temperature control delay and low efficiency due to the fact that the heat exchange is carried out only by a jacket of the autoclave body in common use at present.

### TECHNICAL FIELD

The invention relates to the technical field of foaming equipment, in particular to a polymer material supercritical fluid foaming autoclave with internal heat exchange.

### BACKGROUND ART

Supercritical fluid foaming technology has recently been introduced into the field of polymer material foaming. In order to stabilize product quality and improve production efficiency, this technology has great development space in process research, equipment structure design and others. The structure design of supercritical fluid foaming kettle is one of the key factors affecting product quality and production efficiency.

In the foaming process of polymer material, due to the different foaming materials, different foaming processes and the change of process parameters in the foaming process of the same material, the temperature in a foaming autoclave is required to be adjusted frequently. The temperature is an important factor for controlling quality of space polymer foaming products, and the foaming shape and size of solid products are directly influenced. The temperature in the autoclave is controlled by the foaming process to be increased and increased quickly, with stable temperature value. A heat exchange member of the supercritical fluid foaming autoclave commonly used now is only provided with an external jacket, the foaming autoclave is high-pressure equipment, the thickness of the autoclave body is very large, the heat exchange heat transfer efficiency is low only by the jacket, the temperature change is delayed, the temperature in the autoclave is not favorably adjusted rapidly, and the foaming autoclave which simply exchanges heat by the jacket of the autoclave body cannot meet the requirements of the foaming process.

### SUMMARY OF THE INVENTION

It is an object of the present invention to overcome the above-mentioned drawbacks of the prior art and to provide a polymer material supercritical fluid foaming autoclave with internal heat exchange.

In order to achieve the purpose, the invention provides a polymer material supercritical fluid foaming autoclave with internal heat exchange, comprising an autoclave body, an end cover and a spiral heat exchange coil pipe, wherein the autoclave body is horizontally arranged, the interior of the autoclave body is hollow, one end of the autoclave body is opened to form an open end, and the other end of the autoclave body is closed to form a sealed end; the autoclave body is provided with a high-pressure fluid inlet and a high-pressure fluid outlet which are respectively communicated with the interior of the autoclave body, and the end cover is sealingly mounted inside the open end of the autoclave body to seal the open end of the autoclave body; and the heat exchange coil pipe is positioned inside the autoclave body and is mounted against an inner wall of the autoclave body, an inlet end and an outlet end of the heat exchange coil pipe pass through hole positions of the autoclave body respectively and extend to the outside, and a high-temperature heat exchange medium and/or a low-temperature heat exchange medium can be introduced into the heat exchange coil pipe.

The inlet end and the outlet end of the heat exchange coil pipe are respectively and sealingly connected with the hole positions of the autoclave body in a welding manner.

A sealing ring is arranged between the end cover and the inner wall of the autoclave body, and the end cover is sealingly arranged inside the open end of the autoclave body by the sealing ring so as to realize high-pressure self-tightening sealing between the end cover and the autoclave body.

A heat-preservation jacket is arranged outside the autoclave body, a heat-preservation interlayer is formed between the heat-preservation jacket and the autoclave body, and a heat-preservation medium inlet and a heat-preservation medium outlet which are respectively communicated with the heat-preservation interlayer are arranged on the heat-preservation jacket.

A support for supporting is arranged outside the heat-preservation jacket.

A material frame is placed inside the autoclave body and fixedly connected with an inner end part of the end cover, the material frame is a frame type structure used for loading or hanging materials, and guide wheels are arranged at the bottom of the material frame.

An outer end part of the end cover is provided with at least two wedge blocks and at least two wedge block driving devices, the inner wall of the open end of the autoclave body is provided with clamping grooves for clamping and matching with the wedge blocks, the wedge block driving devices are in transmission connection with the wedge blocks, and the wedge block driving devices can drive the corresponding wedge blocks to move in a radial direction, so that the wedge block can be clamped into the clamping groove of the autoclave body when the end cover is locked or can be separated from the clamping groove of the autoclave body when the cover is opened.

The wedge block is provided with five ones, the wedge block driving device is provided with five ones, each wedge block is respectively provided with an arc shape, the five wedge blocks can be combined to form an annular structure, and the clamping groove is formed to be an annular clamping groove.

The wedge block driving device is provided as an air cylinder.

Compared with the prior art, the invention has the the following beneficial effects.

According to the invention, the internal heat exchange coil pipe is adopted for heat exchange, so that the heat exchange medium can directly and efficiently exchange heat with the supercritical fluid in the autoclave, and the heat exchange efficiency is improved, which solves the problems of temperature control delay and low efficiency due to the fact that the heat exchange is carried out only by the jacket of the autoclave body in common use at present. Therefore, the temperature control in the autoclave is more accurate, the regulation is more rapid and convenient, the product quality is further improved, and the production efficiency is improved, which well meet the foaming process requirements.

### BRIEF DESCRIPTION OF THE DRAWINGS

FIG. 1 is a structurally schematic view of a polymer material supercritical fluid foaming autoclave with internal heat exchange (material frame hidden);

FIG. 2 is a structurally schematic view of an autoclave body with a heat exchange coil pipe hidden;

FIG. 3 is a structurally schematic view of an end cover and components attached to the end cover; and

FIG. 4 is a combined state diagram of wedge blocks.

### DETAILED DESCRIPTION OF THE INVENTION

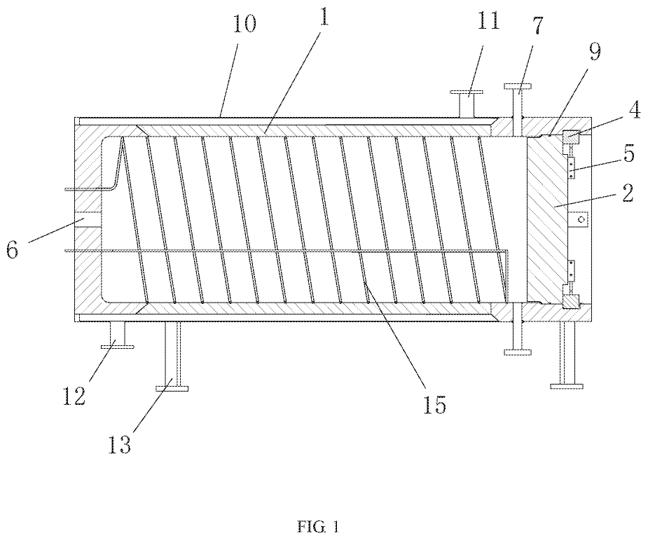

Referring to FIG. 1, embodiments of the present invention provide a polymer material supercritical fluid foaming autoclave with internal heat exchange, comprising components, such as an autoclave body 1, an end cover 2, and a spiral heat exchange coil pipe 15, each of which is described in detail with reference to the accompanying drawings.

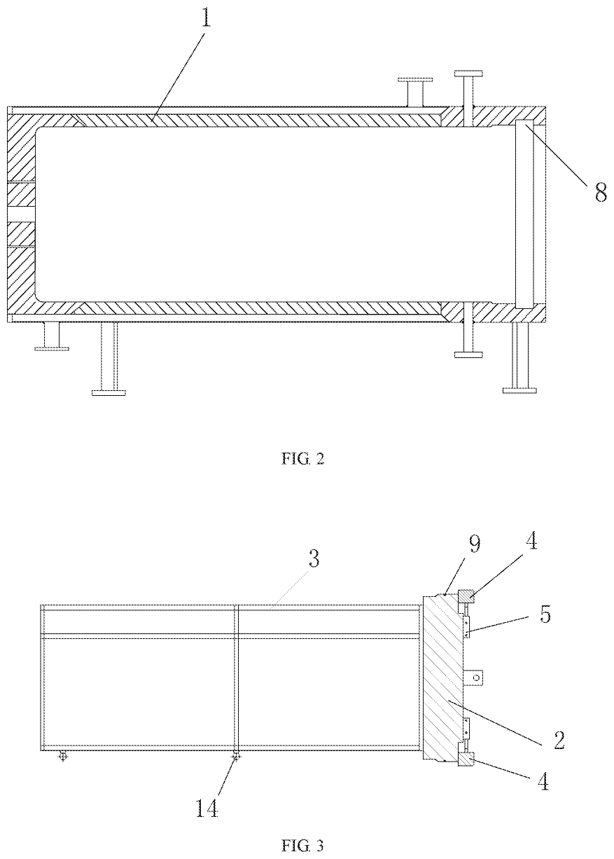

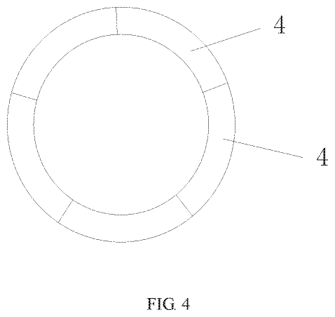

As shown in FIGS. 1 and 2, the autoclave body 1 is horizontally arranged, so that loading operation, cleaning operation or other operations of materials are facilitated, the interior of the autoclave body 1 is hollow, one end of the autoclave body 1 is opened to form an open end, and the other end of the autoclave body 1 is closed to form a sealed end. In addition, the autoclave body 1 is provided with a high-pressure fluid inlet 6 and a high-pressure fluid outlet 7 which are respectively communicated with the interior of the autoclave body 1, the high-pressure fluid inlet 6 can be arranged at the sealed end of the autoclave body 1, and the high-pressure fluid outlet 7 can be arranged at the top and/or the bottom of the autoclave body 1 and close to the open end of the autoclave body 1.

As shown in FIGS. 1 and 3, the end cover 2 is sealingly arranged inside the open end of the autoclave body 1 and can close the opening of the autoclave body 1, an O-shaped sealing ring 9 is arranged between the end cover 2 and the inner wall of the autoclave body 1, and the end cover 2 can realize high-pressure self-tightening sealing with the autoclave body 1 by the sealing ring 9.

As shown in FIG. 1, the heat exchange coil pipe 15 is arranged inside the autoclave body 1 and is mounted against the inner wall of the autoclave body 1, the inlet end and the outlet end of the heat exchange coil pipe 15 pass through the hole position of the autoclave body 1 respectively and extend to the outside, a high-temperature heat exchange medium and/or a low-temperature heat exchange medium can be introduced into the heat exchange coil pipe 15, and the heat exchange medium can be preferably a common liquid heat exchange medium.

Preferably, the inlet end and the outlet end of the heat exchange coil pipe 15 can be respectively and sealingly connected with the hole positions of the autoclave body 1 in a welding manner, and the welding structure meets the Chinese Pressure Vessel Standard GB150-2011.

As shown in FIG. 3, a material frame 3 can be placed inside the autoclave body 1, one end of the material frame 3 is fixedly connected with an inner end of the end cover 2, and the material frame 3 is provided in a frame type structure for loading or hanging materials such as stereoscopic soles, sheet materials, other forming members, bulk particles and the like, wherein the end cover is connected with the material frame to form an integrated structure, so that entering/leaving of the material frame and opening/closing, of the end cover are integrated, and thus the end cover only needs to move in one axial direction, so that the operation is simpler and more convenient, and after the cover is opened, the end cover is not required for radial avoidance movement due to the entering/leaving of the material frame, the cover opening operation is simplified, and the operation space is saved.

Preferably, the bottom of the material frame 3 may also be provided with guide wheels 14 to facilitate entering/leaving movement of the material frame 3.

In addition to increasing the heat exchange area and improving the heat exchange efficiency, the heat exchange coil pipe 15 is arranged in a spiral shape and is mounted against the inner wall of the autoclave body 1 so as not to obstruct the entering of the material frame 3 or the feeding of the foaming material, thereby facilitating the loading operation, the cleaning operation or other operations of the material.

As shown in FIG. 1, a heat-preservation jacket 10 can be arranged outside the autoclave body 1, a heat-preservation interlayer is formed between the heat-preservation jacket 10 and the autoclave body 1, and a heat-preservation medium inlet 11 and a heat-preservation medium outlet 12 which are respectively communicated with the heat-preservation interlayer are arranged on the heat-preservation jacket 10. Preferably, the heat-preservation medium inlet 11 may be provided at the top of one end of the autoclave body 1, the heat-preservation medium outlet 12 may be provided at the bottom of the other end of the autoclave body 1, and the heat-preservation medium may be a liquid such as hot water, hot oil, etc.

Further, the outside of the heat-preservation jacket 10 may be provided with a support 13 for supporting the entire foaming autoclave.

As further improvement of the embodiment, as shown in FIGS. 1 and 3, the end cover can be locked and unlocked with the autoclave body by adopting a wedge block type cover mechanism with quick unlocking and locking, the wedge block type cover mechanism with quick unlocking and locking comprises a wedge block driving device 5 and a wedge block 4, the wedge block driving device 5 is mounted at an outer end part of the end cover 2, and the wedge block driving device 5 is in transmission connection with the wedge block 4. The inner wall of the open end of the autoclave body 1 is provided with clamping grooves 8 for clamping and matching with the wedge blocks 4.

In the present embodiment, the wedge blocks 4 may preferably be provided with five ones, the wedge block driving device 5 may preferably be provided with five ones, each of the wedge blocks 4 may be respectively arranged with an arc shape, the five wedge blocks 4 may be combined to form an annular structure as shown in FIG. 5, and accordingly, the clamping grooves 8 of the autoclave body 1 may also be provided as annular clamping grooves matched therewith. The combined wedge block structure has a good locking effect. When specially implemented, the wedge block driving device 5 may preferably be provided as an air cylinder. Of course, in other embodiments, other electric driving devices or manual driving device may be used as long as the respective wedge block 4 can be driven to move in the radial direction.

After the end cover is pushed inside the open end of the autoclave body 1, the wedge block driving devices 5 can drive the corresponding wedge blocks 4 to move in the radial direction, so that the wedge blocks 4 can be clamped into the clamping grooves 8 of the autoclave body 1 to lock the end cover 2. When the cover is opened, the wedge block driving device 5 can drive the wedge block 4 to be separated from the clamping groove 8 of the autoclave body 1.

The end cover of the foaming autoclave is arranged at an inner diameter position inside the open end of the autoclave body. Compared with an autoclave adopting a clamp hoop type cover opening structure, the end cover is not required to adopt the same outer diameter size as the autoclave body, so that the size of the end cover is greatly reduced, and the weight is light; a wedge block type cover mechanism with quick unlocking and locking is adopted, and the wedge block driving devices can drive the corresponding wedge blocks to move in the radial direction, so that the wedge blocks can be clamped into the clamping grooves at the inner wall of the open end of the autoclave body to lock the end cover or the wedge block can be separated from the clamping groove of the autoclave body to open the cover. The structure is simple and compact, the design is reasonable, the sealing is more reliable, the end cover can be opened/closed more simply and conveniently, and the wedge blocks are mounted inside the open end of the autoclave body together with the end cover, so that the installation space is saved.

The working principle of the invention is as follows:

Filling materials: the foaming material is loaded into the material frame, the material frame and the end cover are loaded into the autoclave body together, and the wedge block driving device pushes the wedge block to lock the end cover and the autoclave body, so as to complete material loading and cover closing operations.

Pressurizing: after filling the materials, the preheated high-pressure supercritical fluid is injected into the autoclave body through the high-pressure fluid inlet; the internal pressure of the autoclave body gradually rises; and after the pressure reaches the process condition, the pressurizing is stopped and the foaming operation is started.

Heating in the autoclave: when the temperature in the foaming autoclave is required to be raised due to the adjustment of process conditions, the high-temperature heat exchange medium can be introduced into the heat exchange coil pipe to transfer heat with supercritical fluid in the autoclave body, the temperature in the autoclave is increased, and the heating operation is stopped when the temperature meets the process requirements.

Cooling in the autoclave: when the foaming autoclave is required to be cooled due to the adjustment of process conditions, the low-temperature heat exchange medium can be introduced into the heat exchange coil pipe to transfer heat with supercritical fluid in the autoclave body, the temperature in the autoclave is reduced, and the cooling operations is stopped when the temperature meets the process requirements.

The horizontal polymer material supercritical fluid foaming autoclave can be applied to the industrial application field of supercritical fluid foaming of stereoscopic soles, sheets, other forming members, bulk particles and other products of polymer materials, and can also be applied to the industrial fields of supercritical fluid dyeing, supercritical fluid aerogel drying, supercritical fluid extraction, and so on.

In summary, according to the invention, the internal heat exchange coil is adopted for heat exchange, so that the heat exchange medium can directly and efficiently exchange heat with the supercritical fluid in the autoclave, and the heat exchange efficiency is improved, which solves the problems of temperature control delay and low efficiency due to the fact that the heat exchange is carried out only by the jacket of the autoclave body in common use at present. Therefore, the temperature control in the autoclave is more accurate, the regulation is more rapid and convenient, the product quality is further improved, and the production efficiency is improved, which well meet the foaming process requirements.

The above-described embodiments are preferred embodiments of the present invention, but the implementations of the present invention are not limited to the above-described embodiments, and any other changes, modifications, replacements, combinations, and simplifications, which do not depart from the spirit and principles of the present invention, are intended to be equivalent substitutions and included within the scope of the present invention.

1. A polymer material supercritical fluid foaming autoclave with internal heat exchange, comprising an autoclave body, an end cover and a spiral heat exchange coil pipe, wherein the autoclave body is horizontally arranged, the interior of the autoclave body is hollow, one end of the autoclave body is opened to form an open end, and the other end of the autoclave body is closed to form a sealed end; the autoclave body is provided with a high-pressure fluid inlet and a high-pressure fluid outlet which are respectively communicated with the interior of the autoclave body, and the end cover is sealingly mounted inside the open end of the autoclave body to seal the open end of the autoclave body; and the heat exchange coil pipe is positioned inside the autoclave body and is mounted against an inner wall of the autoclave body, an inlet end and an outlet end of the heat exchange coil pipe pass through hole positions of the autoclave body respectively and extend to the outside, and a high-temperature heat exchange medium and/or a low-temperature heat exchange medium can be introduced into the heat exchange coil pipe.

2. The polymer material supercritical fluid foaming autoclave with internal heat exchange according to claim 1, wherein the inlet end and the outlet end of the heat exchange coil are respectively and sealingly connected with the hole positions of the autoclave body in a welding manner.

3. The polymer material supercritical fluid foaming autoclave with internal heat exchange according to claim 1, wherein a sealing ring is arranged between the end cover and the inner wall of the autoclave body, and the end cover is sealingly arranged inside the open end of the autoclave body by the sealing ring so as to realize high-pressure self-tightening sealing between the end cover and the autoclave body.

4. The polymer material supercritical fluid foaming autoclave with internal heat exchange according to claim 1, wherein a heat-preservation jacket is arranged outside the autoclave body, a heat-preservation interlayer is formed between the heat-preservation jacket and the autoclave body, and a heat-preservation medium inlet and a heat-preservation medium outlet which are respectively communicated with the heat-preservation interlayer are arranged on the heat-preservation jacket.

5. The polymer material supercritical fluid foaming autoclave with internal heat exchange according to claim 4, wherein a support for supporting is arranged outside the heat-preservation jacket.

6. The polymer material supercritical fluid foaming autoclave with internal heat exchange according to claim 1, wherein a material frame is placed inside the autoclave body and fixedly connected with an inner end part of the end cover, the material frame is a frame type structure used for loading or hanging materials, and guide wheels are arranged at the bottom of the material frame.

7. The polymer material supercritical fluid foaming autoclave with internal heat exchange according to claim 1, wherein an outer end part of the end cover is provided with at least two wedge blocks and at least two wedge block driving devices, the inner wall of the open end of the autoclave body is provided with clamping grooves for clamping and matching with the wedge blocks, the wedge block driving devices are in transmission connection with the wedge blocks, and the wedge block driving devices can drive the corresponding wedge blocks to move in a radial direction, so that the wedge block can be clamped into the clamping groove of the autoclave body when the end cover is locked or can be separated from the clamping, groove of the autoclave body when the cover is opened.

8. The polymer material supercritical fluid foaming autoclave with internal heat exchange according to claim 7, wherein the wedge blocks are provided with five ones, the wedge block driving devices are provided with five ones, each wedge block is respectively arranged with an arc shape, the five wedge blocks can be combined to form an annular structure, and the clamping groove is formed to be an annular clamping groove.

9. The polymer material supercritical fluid foaming autoclave with internal heat exchange according to claim 7, wherein the wedge block driving device is provided as an air cylinder.
